(19) United States
(12) Patent Application Publication
(10) Pub. No.: US 2009/0026743 A1
(43) Pub. Date: Jan. 29, 2009

(54) DUAL CHAMBER AIRBAG MODULE WITH ANTI-RETURN DIFUSER

(75) Inventor: Luis Arez, Valladolid (ES)

Correspondence Address: LADAS & PARRY LLP, 26 WEST 61ST STREET, NEW YORK, NY, 10023, US

(73) Assignee: DALPHI METAL ESPANA, S.A..

(21) Appl. No.: 12/174,827

(22) Filed: Jul. 17, 2008

(30) Foreign Application Priority Data
Jul. 27, 2007 (EP) 07381054.1

(51) Int. Cl. B60R 21/26

(52) U.S. Cl. 280/740

(57) ABSTRACT

Airbag module for a car that consists of a bag (11) consisting of at least two chambers (13, 15) inflatable with gas produced by a generator (21) and providing to each one of them via outlets from a distributor conduit (23) connected to the generator (21); the outlets would be configured to provide varying gas pressure in such chambers (13, 15) that also include a diffuser (31, 33, 35, 37) associated to said distribution conduit 823) in order to prevent the passage of gas between the chambers (13, 15) through such distribution conduit (23) after finishing the gas supply from the generator (21) in order to maintain different pressure levels in both chambers (13, 15) during the entire interaction period with the occupant.

### INVENTION FIELD

This invention refers to an airbag module for cars with dual chamber bag and, more specifically, a side airbag module with a thorax chamber and a pelvis chamber.

### INVENTION BACKGROUND

In previous technology they are known as side airbags that, in order to better protect vehicle occupants, have two chambers, one focused to protect the thorax (or thorax/pelvis combination) and another to protect the pelvis (or complement the pelvic protection), and those that, in the event of collision, are supplied gas at two different pressure levels, less for the thorax chamber than the pelvis chamber.

In this sense, the document EP 1 340 656 describes a side airbag module with two chambers, which are supplied gas produced by a generator through a distributor conduit with two output nozzles for each one of the chambers in which the desired pressure of each chamber is achieved by suitably sizing each one of the nozzles.

In addition, document WO 2005/113300 describes a side airbag module with a thorax/pelvis chamber and a pelvis chamber which are supplied gas produced by a generator through a distribution conduit through certain orifices. This side airbag module can include additional means for better distribution of gas in the thorax/pelvis chamber.

An inconvenience of side airbag modules known in the technology is that once the generator has supplied all the gas available to the two chambers of the bag, the difference in pressure between them forces gas two move from the chamber with greater pressure (the pelvis chamber in this kind of airbag modules) to the chamber of less pressure (the thorax chamber or thorax/pelvis chamber) through said distributor conduit. This circumstance prevents the airbag module from adapting to crashes of varying severity.

This invention is designed to resolve this inconvenience.

### SUMMARY OF THE INVENTION

An objective of this invention is to provide an airbag module with at least two chambers that is adaptable to different conditions of crash or collision severity. The goal is to have different crash configurations and the corresponding evolutions (increase of impact speed, barrier change . . . ) considered by the administrative regulations and/or demanded by consumers.

Another objective of this invention is to provide an airbag module with at least two chambers that maintain different pressure levels during the entire interaction period between the airbag module bag and the vehicle occupant.

Another objective of this invention is to provide a side airbag module with at least two chambers for an effective protection of the thorax and pelvis of the occupant maintaining different levels of pressure during the entire interaction period between the bag of the airbag module and the occupant.

These and other objectives are achieved using a car airbag module that consists of a bag formed by at least two inflatable chambers with gas produced by a generator and provided to each one of them by nozzles of a distributor conduit connected to the generator; the nozzles shall be configured to provide different levels of pressure in such chambers and which also includes a diffuser associated to the distributor conduit to prevent the passage of gas between chambers through said distributor conduit after completing the supply of the generator.

An advantage of this invention is that the adaptability of the airbag module to crash conditions is of passive type and therefore does not require any signal to activate it.

Another advantage of this invention is the ease of integration of an anti-return diffuser in the airbag module.

Another advantage of this invention is low cost involved by the inclusion of said diffuser.

Other characteristics and advantages of this invention shall be drawn from the detailed description following by an execution for illustration purposes but not limited to its purpose with regards to the drawings attached.

### DESCRIPTION OF FIGURES

FIG. 1 is a schematic view of a conventional side airbag with a thorax chamber and pelvis chamber that are supplied gas through a distribution conduit connected to a gas generator.

FIGS. 2a and 2b are schematic views of the execution of this invention in which the anti-return diffuser is a part integrated in the pelvis chamber.

FIGS. 3a and 3b are schematic views, by section A-A′ of FIG. 1, which illustrate the operation of the anti-return diffuser as per this invention: FIG. 3a shows a bag unfold status supplying gas the pelvis chamber and in FIG. 3b, the status of unfolded bag when the generator no longer produces gas.

FIGS. 4a and 4b and FIGS. 5a and 5b are schematic views of two executions of this invention in which the anti-return diffuser is a piece integrated in the two bag chambers.

FIGS. 6a and 6b are schematic views of an execution of this invention in which the anti-return diffuser is a piece integrated in the generator and distribution conduit assembly.

FIGS. 7a and 7b are pressure-time charts in the two chambers of a conventional airbag module and an airbag module as per this invention during its unfolding during a collision.

### DETAILED DESCRIPTION OF THE INVENTION

For the purposes of this invention, the fundamental elements of the airbag module subject of this invention are:

A bag 11 with, at least, two chambers 13, 15. The following detailed description of preferential executions of the invention shall refer to a side airbag module with chambers 13, 15 destined, respectively, to protect the thorax and pelvis of the occupant 17, but is also applicable to any other airbag module, both lateral and frontal, with, at least two chambers configured to unfold in the case of collision with two different levels of gas pressure. Furthermore, chambers 13, 15 can be formed in bag 11 through any of the techniques used in the industry of airbag modules as long as they guarantee sealed separation between them.

A generator 21 with a distribution conduit 23 connected to it with two gas outlets towards each one of the chambers 13, 15. On lateral airbag modules, the distribution conduit 23 is usually located in an area of the bag 11 near the separation of both chambers 13, 15 and duly reinforced so that the distributor conduit 23 can be connected to it. In addition, the generator 21 can be connected to the distribution conduit 23 directly or via an intermediate conduit as it could be located on the vehicle in a different location to the bag 11.

According to this invention, the airbag module also includes a diffuser element with, among others, an anti-return valve function between both chambers 13, 15, which guarantees different pressure levels during all bag unfold phases that can take place during a collision and supports multiple executions such as the ones we have described.

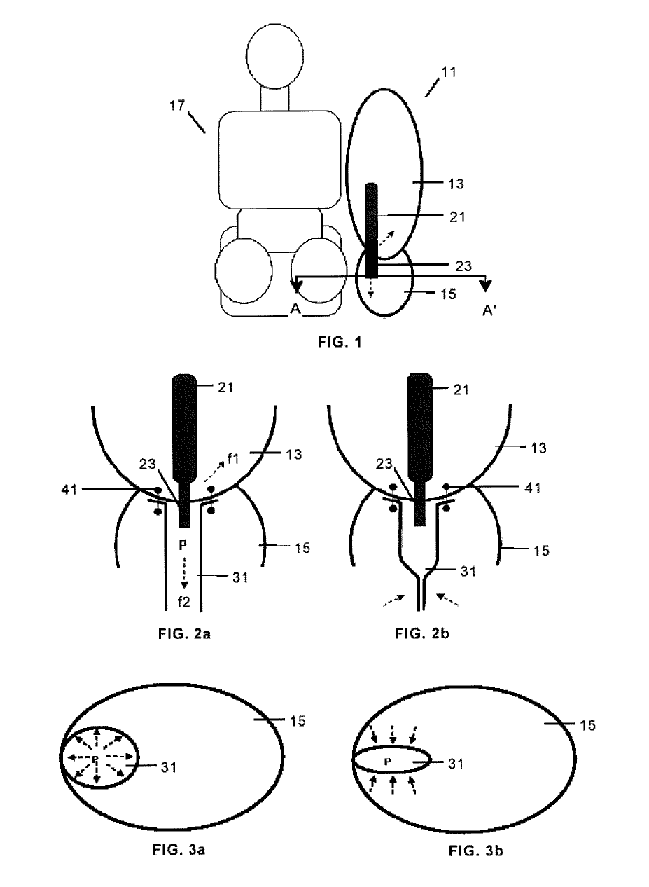

FIGS. 2 and 3 illustrate an airbag module with diffuser 31 in tubular form on the inside of the pelvis chamber 15 and connected to bag 11 via seams 41. The diffuser 31 has greater length than the part of the distributor conduit 23 located inside the pelvis chamber 15.

FIG. 2a shows a bag 11 unfold status that provides gas to chambers 13, 15 through nozzles from the distribution conduit 23 illustrated by arrows f1 and f2 and in which the diffuser 31 does not represent an obstacle to gas passing to the pelvis chamber 15 because, as illustrated in FIG. 3a, pressure P inside is greater than the pressure inside the pelvis chamber 15, which makes the diffuser adopted an expanded form.

FIG. 2b shows the status of bag 11 after the gas supply to the chambers 13, 15 has ended and contact with the occupant. As illustrated in FIG. 3b, the pressure of pelvis chamber 15 is greater than pressure P inside the diffuser 31 closing the diffuser end 31 preventing the gas from pelvis chamber 15 passing to the thorax chamber 13 through the distribution conduit 23.

The diffuser 31 can be performed using fabric similar to bag 11 with our without silicon lining or other suitable flexible material.

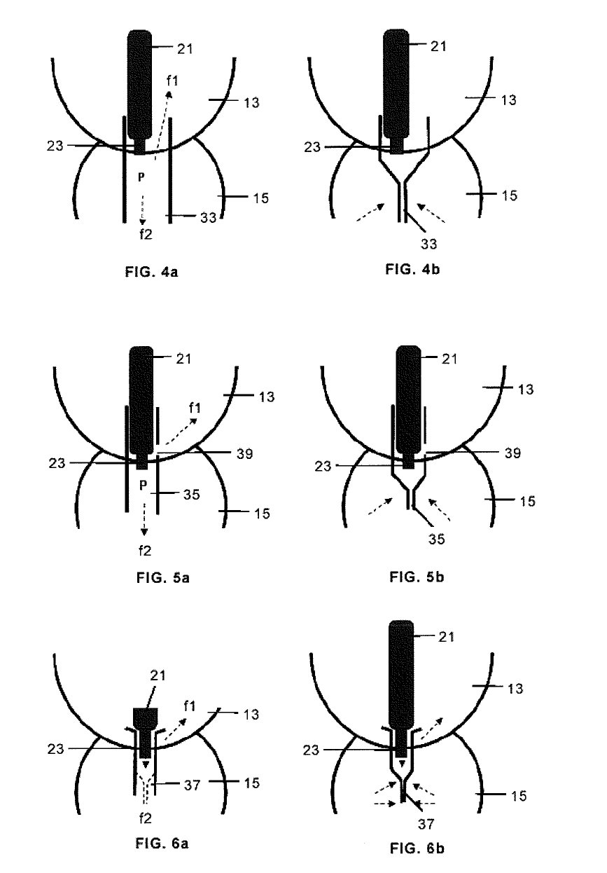

FIGS. 4a and 4b illustrates an airbag module with tubular diffuser 33 integrated in bag 11 that extends to both the pelvis chamber 15 and thorax chamber 13 to fulfil, in addition to preventing gas return from pelvis chamber 15 to thorax chamber 13, a gas distribution function between the two chambers 13, 15 through the outlets illustrated by arrows f1 and f2 fulfilling, at least in part, the function of the distribution conduit mentioned 23 (as schematically illustrated in FIGS. 4a and 4b by representing it as a small dimension). This execution allows reducing the number of parts of the airbag module and consequently reduce weight and cost.

FIGS. 5a and 5b illustrates an airbag module with a diffuser 35 that differences from the execution described in how to distribute gas to chambers 13, 15 and especially the location of gas outlet f1 to thorax chamber 13 through orifice 39.

FIGS. 6a and 6b illustrate an airbag module with a tubular diffuser 37 connected to the generator assembly 21 and the distributor conduit 23 that, otherwise, has a similar function to the airbag module represented in FIGS. 5a and 5b.

The diffuser 37 can be executed in silicone or any other material that on one hand has sufficient elasticity to expand/close in a similar way as described in FIGS. 3a, 3b with regards to diffuser 31 and, on the other, has sufficient thermal resistance.

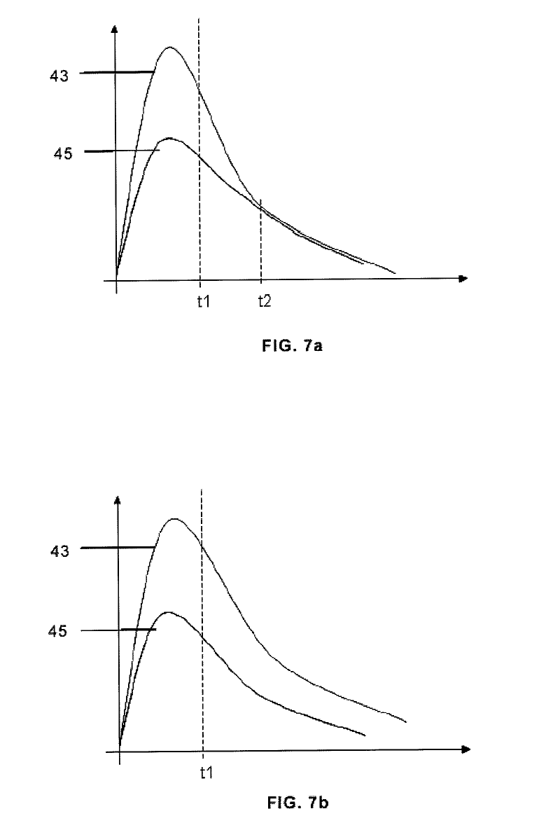

The multiple functionality of a side airbag module with anti-return diffuser as per this invention with regards to a side airbag module is illustrated in FIGS. 7a and 7b through the pressure charts 43, 45 in, respectively, the thorax chamber 13 and pelvis 15.

FIG. 7a shows that the lateral airbag module as per the previous technique, after instant t1 that initiates the interaction between the occupant and the pressure bag 43 of the pelvis chamber 15 will descend until balanced with the pressure 45 of the thorax chamber 13 in instant t2, maintaining both pressure balanced to the end of the interaction between the occupant and bag.

FIG. 7b shows that the lateral airbag module, as per this invention, after instant t1 that initiates the interaction between the occupant and pressure bag 43 of the pelvis chamber 15 continues to be greater than pressure 45 in the thorax chamber 13 until the end of the interaction between the occupant and the bag.

This bag behaviour allows efficiently protecting one same occupant in different crash configurations at different intrusion speeds, for example, a crash configuration with two types of barrier and two speeds or a crash configuration with one barrier and three speeds.

Although we have described and represented several executions of the invention, it is obvious it can be modified within its scope, and should not be considered limited to these executions, but to the content of the following claims:

1. Airbag module for car that includes a bag (11) consisting of at least two chambers (13, 15) inflatable with gas produced by a generator (21) and provided to each one of the through nozzles connected to the distributor conduit (23) connected to the generator (21); such nozzles shall be configured to provide varying gas pressures in the chambers (13, 15), characterized because it also includes a diffuser (31, 33, 35, 37) associated to the distribution conduit (23) in order to prevent the passage of gas between the chambers (13, 15) through the distribution conduit (23) after supplying gas from the generator (21).

2. Airbag module for car according to claim 1, characterized because diffuser (31) consists of a tubular piece made of flexible material connected to the bag (11) and that extends around the distribution conduit in the chamber (15) that receives gas at greater pressure in order to placed inside; the diffuser (31) has a greater length than the part of the distribution conduit (23) located inside.

3. Airbag module for car according to claim 1, characterized because the diffuser (33) consists in a tubular piece of flexible material connected to the bag (11) and that extends around the distribution conduit (23) in both chambers (13, 15) covering its gas outlets; said diffuser (33) shall have in chamber (15) that receives gas at higher pressure, a greater length than the part of the distribution conduit (23) located inside.

4. Airbag module for car according to claim 1, characterized because the diffuser (35) consists of a tubular piece of flexible material connected to bag (11) and that extends around the distribution conduit (23) in both chambers (13, 15) covering its gas exhausts; the diffuser (33) shall have in the chamber (15) that receives the gas at greater pressure a greater length than the distributor conduit part (23) located inside and considering in the chamber (13) that receives gas at less pressure an orifice (39) for distributing gas.

5. An airbag module for cars according to claim 2 characterized because the diffuser (31, 33, and 35) is executed with a tissue equal or similar to the bag (11).

6. Airbag module for car according to claim 1, characterized because the diffuser (37) consists in a tubular piece of flexible material surrounding the distributor conduit (23) and connected to it with the diffuser (37) in the chamber (15) that receives gas at greater pressure a greater length than the part of the distribution conduit (23) located inside it and the chamber (13) that receives gas at less pressure an orifice (39) to distribute gas.

7. An airbag module for cars according to claim 6, characterized because such diffuser (31, 33, 35) is performed with silicone.

8. An airbag module for car according to claims 1, characterized because the airbag module is a lateral airbag module in which the chamber (15) that receives gas at higher pressure is a chamber destined to protect the pelvis and chamber (13) that receives gas at a lower pressure is destined to protect the thorax.
